(19) United States
(12) Patent Application Publication
(10) Pub. No.: US 2019/0235714 A1
(43) Pub. Date: Aug. 1, 2019

(54) CONTEXTUAL KEYBOARD SYSTEMS AND METHODS OF DATA MANAGEMENT

(71) Applicant: Privowny, Inc., Palo Alto, CA (US)

(72) Inventors: Eric Bilange, Paris (FR); Nguyen Hoang, Paris (FR); Hervé Le Jouan, Paris (FR)

(73) Assignee: Privowny, Inc., Palo Alto, CA (US)

(21) Appl. No.: 16/219,748

(22) Filed: Dec. 13, 2018

Related U.S. Application Data
(60) Provisional application No. 62/598,392, filed on Dec. 13, 2017.

(51) Int. Cl. G06F 3/0484; G06F 17/24; G06F 3/0482; G06F 3/0487

(52) U.S. Cl. CPC G06F 3/0484; G06F 3/0487; G06F 3/0482; G06F 17/243

(57) ABSTRACT

A method comprises monitoring one or more applications, the one or more applications including a browser and one or more local apps; recognizing that a user has encountered a form page with a particular application; identifying particular context information associated the particular application and the form page; transmitting the context information to a remote server system, the remote server system storing form data associated with the particular context information; receiving the form data from the remote server system; and presenting a virtual keyboard interface to the user, the virtual keyboard interface enabling the user to access the form data and enter the form data into the form page.

### PRIORITY CLAIM

This application claims priority to and incorporates by reference U.S. Provisional Patent Application Ser. No. 62/598,392, filed Dec. 13, 2017 and entitled “Contextual Keyboard and Mobile Apparatus for Mobile Privacy Management.”

### BACKGROUND

Mobile devices, such as smartphones, tablets, cellphones, etc., are used regularly for managing daily life and providing entertainment. When interacting with browser applications (such as Microsoft Internet Explorer™, Apple Safari™, or Google Chrome™) or non-browser applications (such as Google Android™ apps or Apple iOS™ apps), users often need to access accounts, register new accounts, fill account login or registration forms, etc. Account data is becoming more difficult to remember as users create multiple usernames, passwords and/or emails (if not one per domain/application) to better protect their identity, to increase data security, to avoid spam in their main mailbox, and/or to deliberately have multiple identities.

When entering account data on a website or in an application on a mobile device, users must do a lot of typing using a miniature keyboard. However, typing is not an easy task on small and mobile devices. The problem is exacerbated when the user is on the move.

Some applications offer clumsy solutions to these problems. For example, in many cases, the user must juggle between applications to retrieve relevant account data. Further, these approaches are typically unusable when the mobile device receives an incoming event, such as an incoming telephone call. From the mobile operating system perspective, the incoming event takes priority over the open application, thereby breaking the flow of actions like copy/paste.

Still further, for many reasons (including to enhance security), many mobile operating systems silo applications and execute them in sandboxes to ensure that the applications cannot ‘spy’ on nor interfere with each other. Although an application on a personal computer typically has privileges to read any file (including a user's browsing history) on the connected disk, the same privilege is typically not afforded on most mobile devices. In fact, even Google Android™ systems, which are typically more flexible than Apple iOS™ devices, recently blocked APIs that enable access to browser history. These security restrictions prevent the implementation of non-malicious activities, which could help users with their mobile experience.

Having an “assistant” that can help support account registration, account login and/or form filling would be desirable.

### SUMMARY

The following embodiments are described and illustrated in conjunction with systems, tools, and methods that are meant to be exemplary, illustrative and not limiting in scope. In various embodiments, one or more of the above-described problems may have been reduced or eliminated, while other embodiments are directed to other improvements.

In some embodiments, the present invention provides a client device comprising at least one hardware processor; memory storing a browser, one or more local apps, and instructions that, when executed by the at least one hardware processor, cause the system to perform the following steps: monitoring one or more applications, the one or more applications including the browser and the one or more local apps; recognizing that the user has encountered a form page with a particular application; identifying particular context information associated the particular application and the form page; transmitting the context information to a remote server system, the remote server system storing form data associated with the particular context information; receiving the form data from the remote server system; and presenting a virtual keyboard interface to the user, the virtual keyboard interface enabling the user to access the form data and enter the form data into the form page.

The particular context information may include a URL, an active application, a text prompt, and/or a data type. The form data may include a user name, a password and/or an alias email address. The virtual keyboard interface may be a replacement keyboard for a standard keyboard on the client device. The virtual keyboard interface may include a prediction bar that presents form data options for form data fields in the form page. The virtual keyboard interface may include an interface for enabling the user to select an account from a plurality of accounts.

In some embodiments, the present invention provides a method comprising monitoring one or more applications, the one or more applications including a browser and one or more local apps; recognizing that a user has encountered a form page with a particular application; identifying particular context information associated the particular application and the form page; transmitting the context information to a remote server system, the remote server system storing form data associated with the particular context information; receiving the form data from the remote server system; and presenting a virtual keyboard interface to the user, the virtual keyboard interface enabling the user to access the form data and enter the form data into the form page.

The particular context information may include a URL, an active application, a text prompt, and/or a data type. The form data may include a user name, a password, and/or an alias email address. The virtual keyboard interface may be a replacement keyboard for a standard keyboard on the client device. The virtual keyboard interface may include a prediction bar. The method may further comprise presenting form data options in the prediction bar part of the virtual keyboard interface, the form data options being for form data fields in the form page. The method may further comprise enabling the user to select an account from a plurality of accounts using the virtual keyboard interface.

### BRIEF DESCRIPTION OF THE DRAWINGS

FIG. 1 is a block diagram depicting an data management network system, in accordance with some embodiments of the present invention.

FIG. 2A depicts a conventional login page for logging into an account.

FIG. 2B depicts a conventional registration page for registering a new account.

FIG. 3 is a block diagram depicting details of the data control server system, in accordance with some embodiments of the present invention.

FIG. 4 is a block diagram depicting details of the client system, in accordance with some embodiments of the present invention.

FIG. 5 is a block diagram depicting details of the contextual keyboard system, in accordance with some embodiments of the present invention.

FIG. 6A depicts a client device interface including a virtual keyboard, in accordance with some embodiments of the present invention.

FIG. 6B depicts a client device interface including a virtual keyboard, in accordance with some embodiments of the present invention.

FIG. 6C depicts a client device interface including a virtual keyboard, in accordance with some embodiments of the present invention.

FIG. 6D depicts a client device interface including a virtual keyboard, in accordance with some embodiments of the present invention.

FIG. 6E depicts a client device interface including a virtual keyboard, in accordance with some embodiments of the present invention.

FIG. 6F depicts a client device interface including a virtual keyboard, in accordance with some embodiments of the present invention.

FIG. 6G depicts a client device interface including a virtual keyboard, in accordance with some embodiments of the present invention.

FIG. 6H depicts a client device interface including a virtual keyboard, in accordance with some embodiments of the present invention.

FIG. 6I depicts a client device interface including a virtual keyboard, in accordance with some embodiments of the present invention.

FIGS. 7A and 7B depict examples of components suitable for performing the techniques described in this paper.

### DETAILED DESCRIPTION

The following embodiments are described and illustrated in conjunction with systems, tools, and methods that are meant to be exemplary, illustrative, and not limited in scope. In various embodiments, one or more of the above-described problems may have been reduced or eliminated, while other embodiments are directed to other improvements.

In some embodiments, a service on a client device (e.g., mobile device) can help a user complete electronic forms, such as login pages or registration pages, based on what the user usually does online with the website or the type of website. For example, some embodiments of the service can help the user login using previously used credentials that are safely stored in the cloud or locally in a personal storage box. Some embodiments of this service improve security, reduce the amount of typing required by the user, and manage the form data on behalf of the user.

Further, some embodiments of the service provide and/or cooperate with a user interface integrated into a virtual keyboard. The service may include an extension that cooperates with a virtual keyboard to offer data management and form-filling support. In some embodiments, the extension senses the context (e.g., the current active application, the last application in use, the current network domain, the last network domain, the field type(s), text prompts, etc.). In some embodiments, the extension uses the VPN service, the Accessibility service, and/or the Classification service of the mobile phone. Some embodiments of the extension may fetch the form data from an online or local repository. Some embodiments of the virtual keyboard may enable easy selection of the form data for entry into the form page, e.g., the login page, the registration page, or other form-filling page.

In some embodiments, the extension can predict the form data needed based on the context, and the virtual keyboard can present the predicted data in a convenient manner. Further the virtual keyboard may present an interface to enable generation of unique emails, usernames, and/or passwords.

In some embodiments, the user no longer needs to switch between applications to retrieve form data and/or no longer needs to type as much form data into the form page. Further, in some embodiments, incoming events/interrupts such as an incoming telephone call will not disrupt the form-filling process (e.g., account login or registration).

To overcome security restrictions, the service may implement permitted functions and may interact with the system and/or user to determine (recognize or infer) user context. Notably, in some embodiments, the user may need to provide consent, e.g., at the time of installation and/or activation of the service, to authorize the functions by the extension and virtual keyboard. Further, the service may be implemented for a variety of different hardware systems, operating systems, brands, vendors, etc.

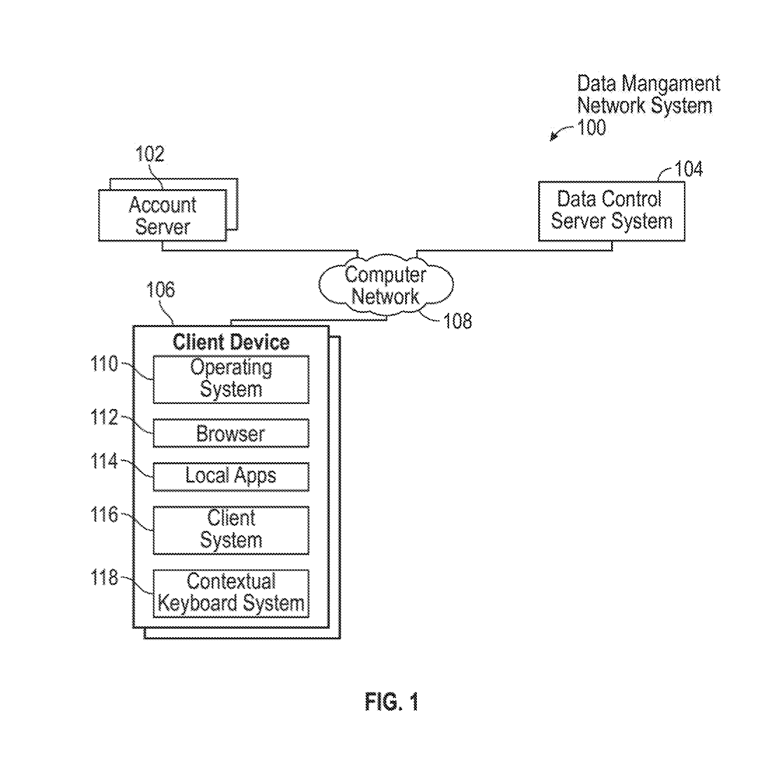

FIG. 1 is a block diagram depicting a data management network system 100, in accordance with some embodiments of the present invention. The data management network system 100 includes a plurality of account servers 102, a data control server system 104, and a plurality of client devices 106, each coupled together via a computer network 108.

Each account server 102 includes hardware, software, and/or firmware configured to host account services accessible via a browser application or other application (e.g., mobile phone app). In some embodiments, each account server 102 grants access to the account services only after the account server 102 has registered the user and/or only after the account server 102 has logged in the registered user. User registration may include providing account access information (e.g., a username and a password), contact information (e.g., an email, telephone number, and address information), demographic information (e.g., age, gender, occupation, and marital status), and/or the like. After registration, the user can subsequently login to access the account services without having to re-register. Examples of account services include YouTube, Facebook, LinkedIn, Bank of America, USPTO, Spotify, Netflix, etc.

The data control server system 104 includes a processor-based system, such as a desktop or laptop, configured to manage the form data on behalf of users. Form data may include account registration data, account login data, and/or other data (especially if recurring). In some embodiments, the data control server system 104 may provide an online repository of form data, e.g., data previously entered by a user into a web page or app. The data control server system 104 may associate the form data with relevant context information to support future retrieval of the form data when needed by the user. Examples of context information may include an application identifier, an active URL, a past URL, a data type (e.g., password type), and/or a text prompt identifying the data to be entered in a field. Example text prompts to request a login name may include “username”, “userid”, “user identifier”, “account name”, “email address”, and/or other possible login prompt.

In some embodiments, the data control server system 104 may provide aliasing functionality to generate alias data (e.g., an alias email address, an alias telephone number, an alias geographic address, etc.) for the user. The data control server system 104 may include a server system such as described in U.S. Pat. No. 9,699,133, which describes in details the systems and processes for generating aliases. U.S. Pat. No. 9,699,133 is hereby incorporated by reference.

The data control server system 104 is further configured to manage storage of the form data in association with the context information. Thus, when the data control server system 104 receives context information in the future from a client device 106, the data control server system 104 is capable of using the context information to select and/or retrieve appropriate form data. The data control server 104 may send the form data to the client device 106 for presentation to the user, for access by the user, and/or for automatic entry into the fields of the form page.

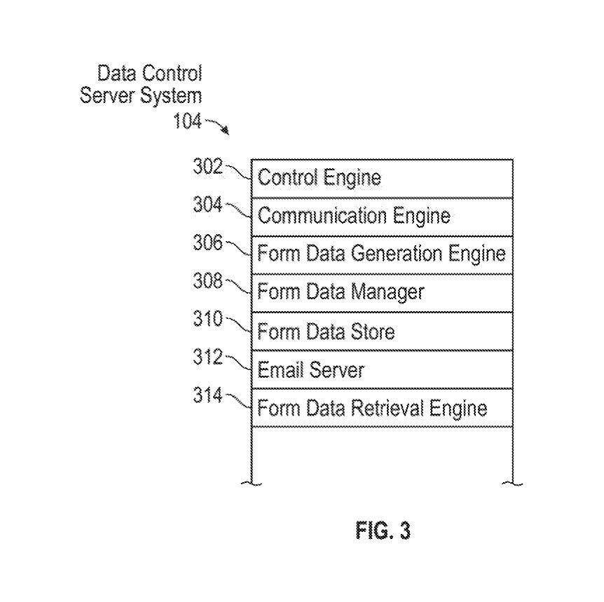

The data control server system 104 is further described with reference to FIG. 3.

In some embodiments, each client device 106 includes a processor-based system, such as a desktop, laptop, smart pad, smart phone, etc., configured to execute an operating system 110, a browser 112, and local apps 114. The operating system 110 may include any operating system such as Google Android™, Apple iOS™, Apple MacOS™, Linux™, and Microsoft Windows™. The browser 112 includes hardware, software and/or firmware configured to navigate websites and present web pages to users. Example browsers 112 include Microsoft Internet Explorer™, Apple Safari™, Mozilla Firefox™ and Google Chrome™. The local apps 114 may include mobile apps, such as the Gmail app, BankofAmerica app, LinkedIn app, Facebook app, YouTube app, Spotify app, and Netflix app. Like web pages (which are accessible via the browser 112), each of the location apps 114 may request registration data, login data, and/or other form data. It will be appreciated that the browser 112 and the local apps 114 are both examples of applications capable of accessing account services and receiving the form-filling support provided by the embodiments herein.

In some embodiments, each client device 106 further includes a client system 116 and a contextual keyboard system 118. The client system 116 includes hardware, software and/or firmware configured to support data management and form filling as discussed herein. The client system 116 may include an extension (or plugin), such as described in U.S. Pat. No. 9,699,133.

In some embodiments, the client system 116 captures form data entered into the fields of a form page and captures the context associated with the form page and/or form data. In some embodiments, the client system 116 monitors the context, e.g., the active or a previous application (which may be a browser 112 or one of the local apps 114), the active URL, the network domain, the field type, the text prompt, etc., where form data is being provided. The client system 116 may sense the context using, for example, the VPN service, the Accessibility service, and/or the Classification service of the client device 106. In some embodiments, the client system 116 provides the form data and the context to the data control server system 104 for management and future retrieval.

In some embodiments, the client system 116 cooperates with the data control server system 104 to manage generation of form data. For example, the client system 116 may receive a request for the generation of form data, such as an email address, username, password, phone number, geographic address, and/or the like. In some embodiments, the form data being generated by the data control server system 104 may include alias data. The client system 116 may send the request to the data control server system 104 to generate the particular form data and may receive back the generated form data for selection or automatic entry into the appropriate field(s) of the form page.

In some embodiments, the client system 116 cooperates with the data control server system 104 to help a user complete a form page encountered in the future. For example, the client system 116 can help the user retrieve prior credentials previously entered, e.g., by determining the context information of the current form page (possibly at the field level). The data control server 104 recognizes the context information of the form page, e.g., as a login page at a particular URL or generated by a particular app, and retrieves the form data based on the stored context information previously stored when the user registered or last modified the form data. In some embodiments, the data control server 104 recognizes the context of a form page, e.g., as a registration page, and predicts form data needed, e.g., name, email address, etc.

In some embodiments, the client system 116 provides and/or cooperates with a contextual keyboard system 118 for providing form-filling support. The contextual keyboard system 118 generates a virtual keyboard that can be used in the place of the standard virtual keyboard on the client device 106. In addition to the virtual keyboard, the contextual keyboard system 118 may present form data for easy selection and entry into the fields of a form page. In some embodiments, the form data may be presented in a prediction bar that may be located above (or below) the virtual keyboard. In some embodiments, after the user has clicked into a field on a form page, the user can select a prediction content item (e.g., a first name, a username, or an email) in the prediction bar to populate the field. In some embodiments, the contextual keyboard system 118 presents one or more account identifiers in lieu of the form data itself. Upon selection of the account identifier, the contextual keyboard system 118 may enter the associated form data (e.g., the username which in some embodiments may be the email address and/or the password) into the relevant field or fields. In some embodiments, the contextual keyboard system 118 presents the form data associated with the account identifier, including the associated username and/or password for selection and entry into the relevant fields (e.g., by clicking or drag/drop or copy/paste). The form data associated with the account identifier may be presented in the prediction bar, in a drop-down menu, or in a pop-up window. Other presentation mechanisms are also possible. In some embodiments, the username, passwords and/or other form data may be redacted, blurred, or otherwise hidden so that the contextual keyboard system 118 does not show confidential data on the screen either in the virtual keyboard or in the text fields of the form page. In some embodiments, the contextual keyboard system 118 presents the form data in a presentation mechanism, but still requires the user to type it into the appropriate field of the form page.

In some embodiments, the contextual keyboard system 118 further presents a form data interface to support dynamic generation of form data, e.g., emails, usernames, and/or passwords. The client system 116 may receive a request for the generation of form data from the form data interface, and may reach out to the data control server system 104 for the data control server system 104 to generate the form data. The client system 116 may receive the generated form data from the data control server system 104, and may provide the generated form data to the contextual keyboard system 118 for presentation of and/or access to the new form data choices on the form data interface. In some embodiments, the form data may be entered directly into the field of the form page, e.g., into the active field with the cursor, into a previously identified/provisioned field, or into an inferred field.

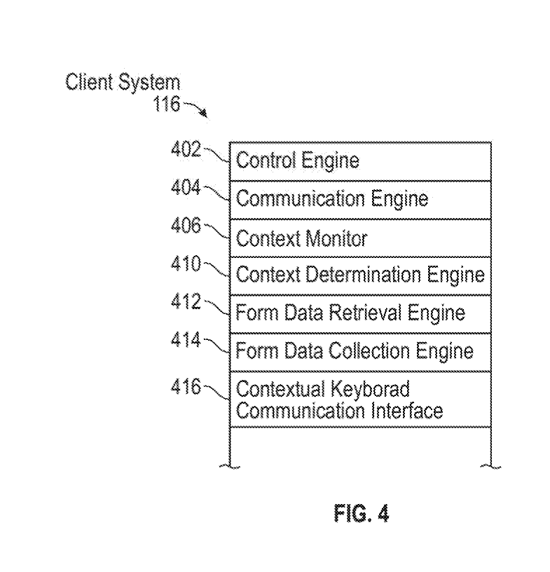

Additional details of the client system 116 are further described with reference to FIG. 4.

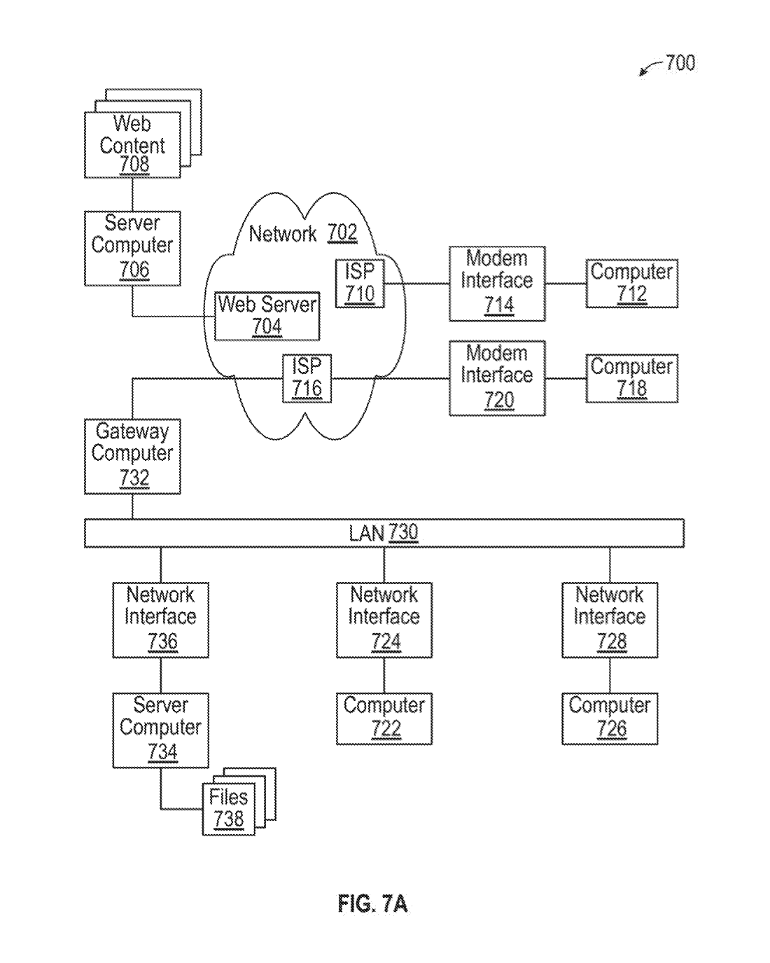

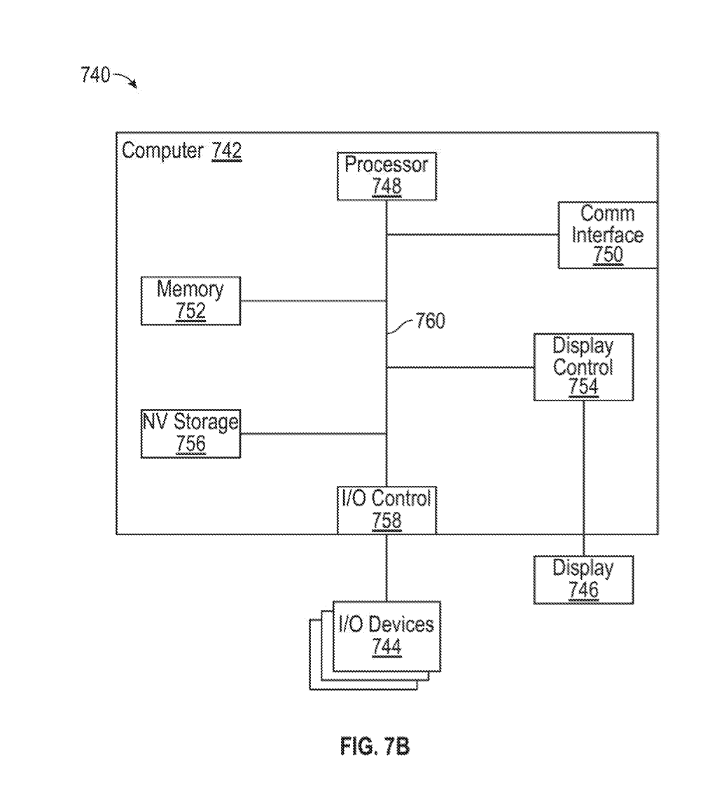

The computer network 108 can include a public or private network, as described with reference to FIGS. 7A and 7B. The computer network 108 may provide communication between client systems 106, account servers 102, data control server system 104 and/or other systems. In some embodiments, the communication network 108 includes one or more computing devices, routers, cables, buses, and/or other network topologies (e.g., mesh, and the like). The communication network 108 may be wired and/or wireless. The communication network 108 may include the Internet, one or more wide area networks (WANs) or local area networks (LANs), public networks, private networks, IP-based networks, non-IP-based networks, and so forth.

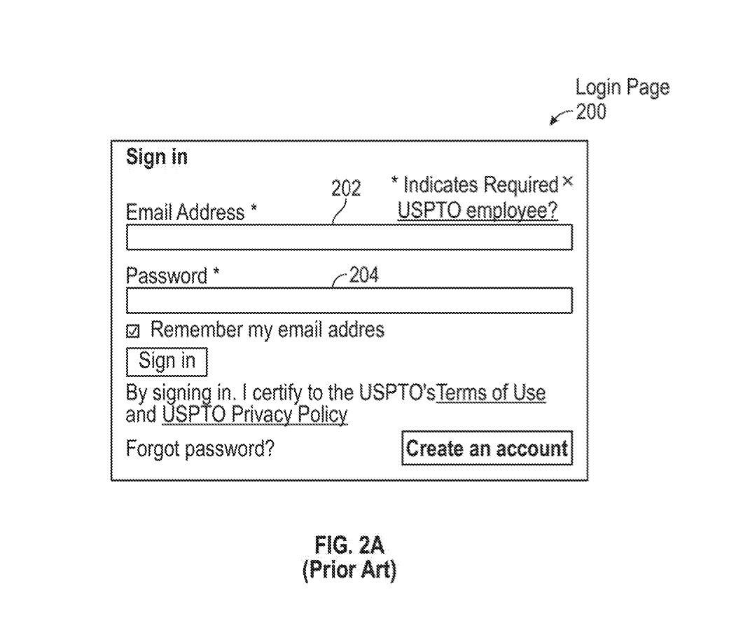

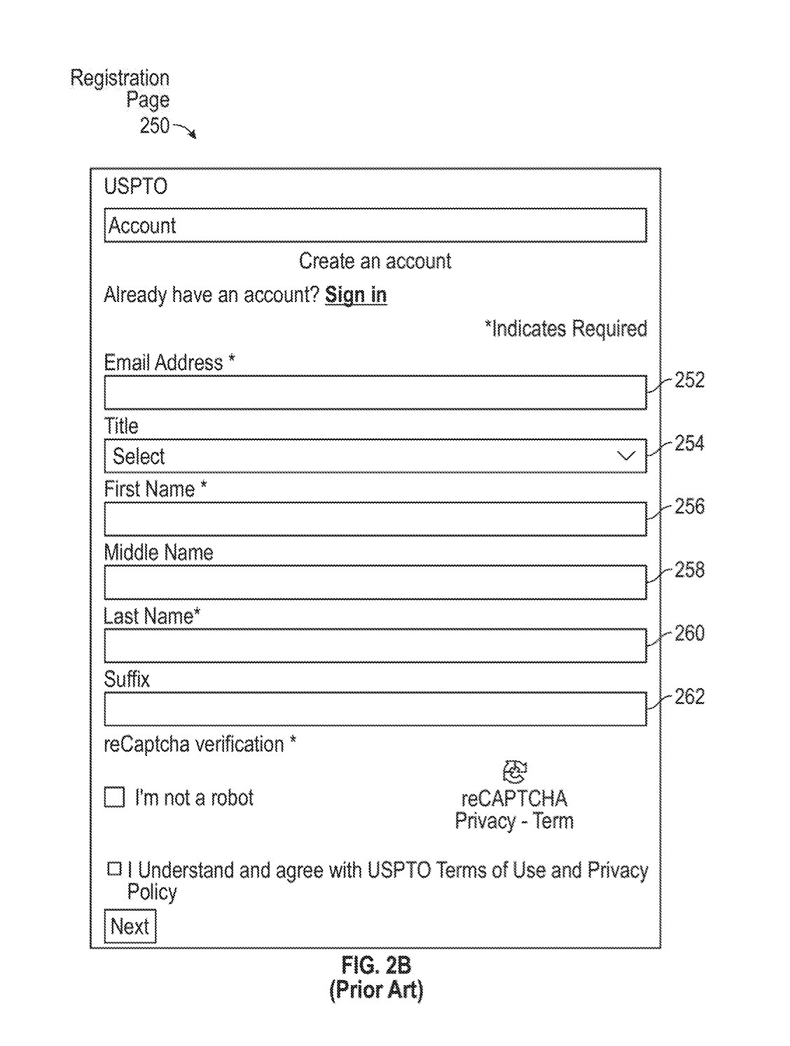

FIG. 2A depicts an example conventional login page 200, which is capable of receiving support from various embodiments of the present invention. In the depicted example, the login page 200 is the USPTO login page. As shown, the example login page 200 includes a first field 202 for requesting an email address as a username, and a second field 204 for requesting a password. Other conventional login pages 200 may have different fields for requesting different information such as a unique identifier or phone number as the username.

FIG. 2B depicts an example conventional registration page 250, which is capable of receiving support from various embodiments of the present invention. In the depicted example, the registration page 250 is the USPTO registration page. The example registration page 250 includes a first field 252 for requesting an email address, a second field (pull-down menu) 254 for requesting a title, a third field 256 for requesting a first name, a fourth field 258 for requesting a middle name, a fifth field 260 for requesting a last name, and a sixth field 262 for requesting a suffix. Other conventional registration pages 250 may have different fields for requesting different information, such as username, password, home address, work address, home phone, work phone, mobile phone, etc. Notably, although not shown on this web page, the USPTO registration process will request a username and password in a subsequent registration page 250.

FIG. 3 is a block diagram depicting details of the data control server system 104, in accordance with some embodiments of the present invention. The data control server system 104 includes a control engine 302, a communication engine 304, a form data generation engine 306, a form data manager 308, a form data store 310, an email server 312, and a form data retrieval engine 314.

The control engine 302 includes hardware, software and/or firmware configured to identify and verify the user, and to manage the components of the data control server system 104. In some embodiments, the control engine 302 verifies user credentials before enabling a client device 106 to access the services of the client system 116 or the data control server system 104. That is, the control engine 302 may require that the client system 116 first obtain a username and password or receive verification of a biometric entry (e.g., fingerprint, facial recognition, etc.) to identify the user, and to verify the user's rights to access the secure services provided by the client system 116 or the data control server system 104.

The communication engine 304 includes hardware, software and/or firmware configured to communicate with the computer network 108. The communication engine 304 may function to send requests, transmit and receive data communications, and/or otherwise communicate with one or a plurality of systems. In some embodiments, the communication engine 304 functions to encrypt and decrypt data communications. The communication engine 304 may function to send requests to and receive data from one or more systems through a network or a portion of a network. Depending upon implementation-specified considerations, the communication engine 304 may function to send requests and receive data through a connection, whether all or part is wireless.

The form data generation engine 306 includes hardware, software and/or firmware configured to generate form data on behalf of a user. Examples of form data include a username, a password, an email address, a first name, a middle name, a last name, a birth date, a home address, a work address, a home phone number, a work phone number, a mobile phone number, credit card number, age, gender, occupation, etc. In some embodiments, the form data generation engine 306 includes an aliasing engine, such as the aliasing engine described in U.S. Pat. No. 9,699,133. The aliasing engine may generate alias data, which may include mock data to replace data that would otherwise identify the true identity of a user or private information about the user. Examples of alias data may include an email address, a name, a birth date, a home address, a work address, a home phone number, a work phone number, a mobile phone number, a credit card number, gender, occupation, etc.

The form data manager 308 includes hardware, software and/or firmware configured to manage storage and retrieval of form data, which may include user-provided data or newly generated data. The form data manager 308 may store the form data with context information (such as the active application, current URL, data type (e.g., password), or text prompts identifying the data being requested by the field) to support retrieval of the form data when the context indicates relevance. In some embodiments, the form data manager 308 stores the form field type based on the form data entered by the current user, so that the form data retrieval engine 314 may infer the field type for a future different user who encounters the same form page. In some embodiments, the field type may be inferred by the client system 116 instead of by the data control server system 104.

The form data store 310 includes memory, persistent data storage, local or remote storage, or other storage device configured to store the form data and context information associated with the form data.

The email server 312 includes hardware, software and/or firmware for managing emails being sent to the email alias generated by the form data generation engine 306. An example email server 312 is described in U.S. Pat. No. 9,699,133. For example, when an alias email address is used instead of a personal email address to register an account or update account data, the email server 312 is configured to manage incoming email. The email server 312 can manage the incoming email based on user preferences, e.g., to forward emails to a personal email address, block the email, etc. In some embodiments, the alias email address includes a domain specific to the email server 312 and includes a unique address associated with the user and the account to which it was provided. Thus, the email server 312 can act as a warning system when an alias email address has been compromised. The email server 312 can check user preferences and email handing rules to determine how to treat each received email message. For example, if user preferences indicate that the alias email address is no longer active due to a time limit on the life of the alias email address, the email server 312 can filter the email. As another example, if the alias email address is being received from an entity other than the entity with which the alias email address was associated, the email server 312 can handle the email in accordance with user preferences and email handling rules, such as by notifying the original entity associated with the alias email address and inquiring how the other entity obtained the alias email address. User preferences may include a preference to be notified when an alias email address has been compromised.

Although not shown, the data control server system 104 may include other alias-support servers, such as a telephone-support server for forwarding alias telephone calls to the a personal telephone number, or a post-mail support system for forwarding post mail sent to an alias address (e.g., geographic address or post office box).

The form data retrieval engine 314 includes hardware, software and/or firmware configured to receive context information from the client device 106, and to retrieve form data from the form data store 310 based on the context information received relative to the context information stored. For example, the form data retrieval engine 314 may receive context information identifying the active application (e.g., the browser 112) and the active URL identifying the active form page (e.g., the active web page). In some embodiments, the form data retrieval engine 314 compares the received context information against stored context information to identify the form data (e.g., username and password) that the user previously entered into the fields on the form page. In some embodiments, the form data retrieval engine 314 needs to evaluate the received context information to predict the form data. For example, the form data retrieval engine 314 may receive the text prompt associated with one or more fields that prompts the user to enter the appropriate information into the field. The form data retrieval engine 314 may use the text prompt to assist in identifying likely relevant form data for the fields. In some embodiments, the form data retrieval engine 314 may use the context information to predict form data that will be needed when no user has ever completed the form page in the past or when the form page has never been provisioned (e.g., the system administrator has taught the system the field types of the fields of a particular form page, such as of a popular account service).

FIG. 4 is a block diagram depicting details of the client system 116, in accordance with some embodiments of the present invention. The client system 116 includes a control engine 402, a communication engine 404, a context monitor 406, a context determination engine 410, a form data retrieval engine 412, a form data collection engine 414, and a contextual keyboard communication interface 416.

The control engine 402 includes hardware, software and/or firmware configured to identify and verify the user, and to manage the components of the client system 116. In some embodiments, the control engine 402 verifies user credentials before enabling a client device 106 to access the services of client system 116 or the data control server system 104. That is, the control engine 402 may require that the client device 106 first obtain a username and password or receive a biometric entry (e.g., fingerprint, facial recognition, etc.) to identify the user accessing the client system 116, and to verify the user's rights to access the secure services provided by the data control server system 104.

The communication engine 404 includes hardware, software and/or firmware configured to communicate with the computer network 108. The communication engine 404 may function to send requests, transmit and receive data communications, and/or otherwise communicate with one or a plurality of systems. In some embodiments, the communication engine 404 functions to encrypt and decrypt data communications. The communication engine 404 may function to send requests to and receive data from one or more systems through a network or a portion of a network. Depending upon implementation-specified considerations, the communication engine 404 may function to send requests and receive data through a connection, whether all or part is wireless.

The context monitor 406 includes hardware, software and/or firmware configured to monitor the context of the browser 112 and/or local apps 114, including the active URL, the form page, the form fields, the text prompts, etc. The context monitor 406 may use the VPN service, the Accessibility service, and/or the Classification service of the client device 106. The context monitor 406 may communicate with the operating system to request the application currently or last in use. Notably, modern mobile operating systems return the application name, package name and other attributes (which are sufficient to determine a unique application). The last application in use is similar, but can indicate that there has been or is an interruption such as an incoming notification, SMS, telephone call, etc.

In some embodiments, the context monitor 406 includes a separate browser monitor for monitoring the context of the browser 112 and a separate app monitor for monitoring the content of the local apps 114. In such case, each of the browser monitor and the app monitor may use the VPN service, the Accessibility service, and/or the Classification service of the client device 106.

In some embodiments, the context monitor 406 can enrich contextual information by obtaining accessed domains. The context monitor 406 can observe network traffic if the application or keyboard also acts as a loop-back VPN. Traffic may be routed to the VPN service and then forwarded to the intended destination and not to a VPN server. The context monitor 406 can observe DNS requests, and thus domains accessed by the current application (or last application). Using a knowledge base of trackers, ad servers, and other technical resources (such as caches, edge networks, libraries, etc.), the context monitor 406 can detect which application domain is accessed, which may be particularly useful when the application is the browser 112. For example, if user accesses www.cnn.com using the browser 112, the VPN client will see the DNS resolution request for this domain, but also for many other services that the page is accessing (such as fonts, google analytics, and other ad networks). Once the VPN client identifies relevant domains, the VPN client can add it to the context information.

In some embodiments, the context monitor 406 can enrich contextual information using accessibility services that permit reading the screen, listening to window, and view switches. For example, if a user is on the login screen of the German newspaper Die Welt, DNS resolution would have spotted diewelt.de and mypass.de—the latter is what the accessibility service can detect but really the account information is associated to www.diewelt.de. The classification service may detect the association between the two domains. The sequence of access, visible to the VPN service, determines that the user is accessing Die Welt but still has to login first on mypass.de.

The context determination engine 410 includes hardware, software and/or firmware configured to use the raw context information obtained from the context monitor 406 to generate the relevant context information that the data control server system 104 needs to manage storage and retrieval of the form data. In some embodiments, the context determination engine 410 selects different context information based on whether the form page is one that the user previously populated, whether the form page is one that any user previously populated, whether the form page that has been previously provisioned, whether the form page is one that appears to have never been populated or provisioned, and/or the like. For example, the context determination engine 410 may need only the active application and/or the URL to identify the context of a form page that has been previously populated or previously provisioned. On the other hand, the context determination engine 410 may need the active application and/or the URL, as well as field types, text prompts and/or other metadata to identify the context of a new form page. In some embodiments, the context determination engine 410 uses the form data itself to assist in generating the context information. For example, the context determination engine 410 may recognize an email address as being entered into the first field, the text prompt “username or email address” associated with the first field, and the URL of the form page. Similarly, the context determination engine 410 may recognize the password as being entered into the second field, the text prompt “password” associated with the second field, the URL of the form page, and the password data type associated with the second field. In some embodiments, the client system 116 does not include the context determination engine 410. In some embodiments, all or part of the context determination engine 410 is integrated into the context monitor 406.

The form data retrieval engine 412 includes hardware, software and/or firmware configured to obtain form data from the data control server system 104 based on the context information. In some embodiments, that form data retrieval engine 412 generates a form data request using the context information generated by the context determination engine 410 or as generated by the context monitor 406, and receives the form data back from the data control server system 104.

The form data collection engine 414 includes hardware, software and/or firmware configured to capture the form data that the user enters into the fields of a form page. For example, the form data collection engine 414 may capture the username or email address entered into a first field, and may capture the password entered into a second field.

The contextual keyboard communication interface 416 includes hardware, software and/or firmware configured to receive form data received by the contextual keyboard system 118 and/or provide form data retrieved from the data control server system 104 to the contextual keyboard system 118 for presentation to or access by the user. In some embodiments, the context keyboard communication interface 416 may also forward predicted text to the contextual keyboard system 118 for presentation to and/or access by the user.

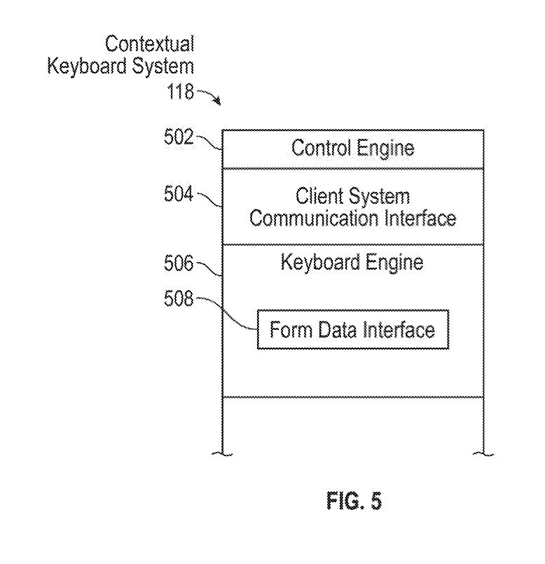

FIG. 5 is a block diagram depicting details of the contextual keyboard system 118, in accordance with some embodiments of the present invention. The contextual keyboard system 118 includes a control engine 502, a client system communication interface 504, and a keyboard engine 506. The keyboard engine 506 includes a contextual data interface 508.

The control engine 502 includes hardware, software and/or firmware configured to manage the components of the client system 116. In some embodiments, the control engine 402 connects the virtual keyboard interface with the underlying client device 106, e.g., to enable the replacement of the standard virtual keyboard with the virtual keyboard interface generated by the contextual keyboard system 118.

The client system communication interface 504 includes hardware, software and/or firmware configured to communicate with the client system 116. In some embodiments, the client system communication engine 504 sends form data entered into the contextual keyboard system 118 to the client system 116 for management by the client system 116 and storage by the data control server system 104, and receives form data from the client system 116 for presentation to or access by the user. In some embodiments, the client system communication interface 504 may also receive predicted text from the client system 116 for presentation to and/or access by the user.

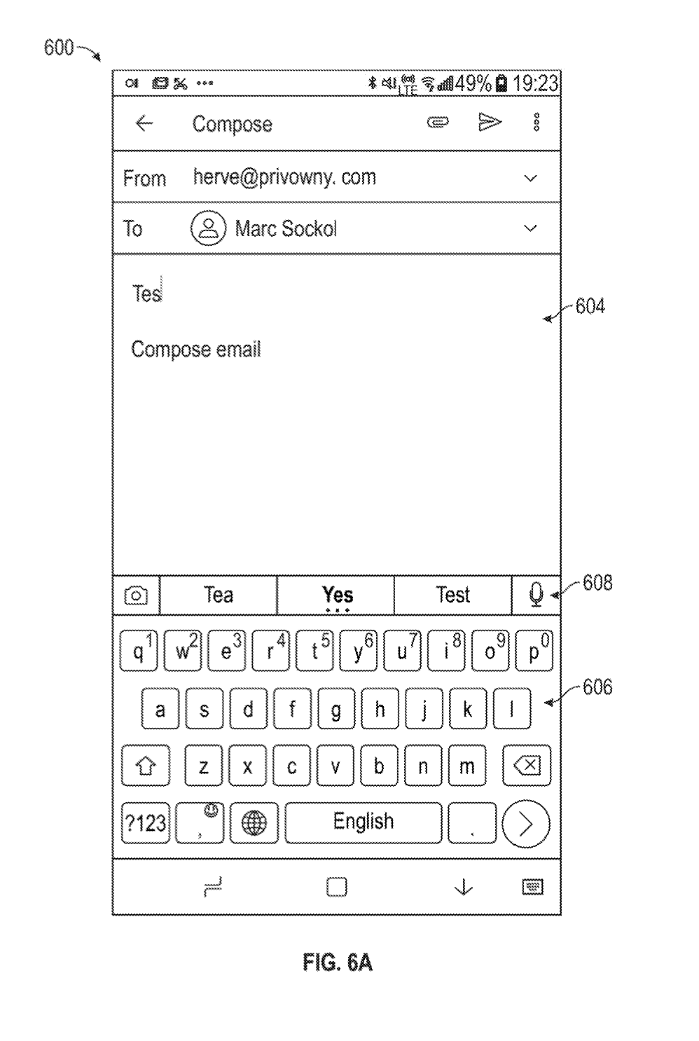

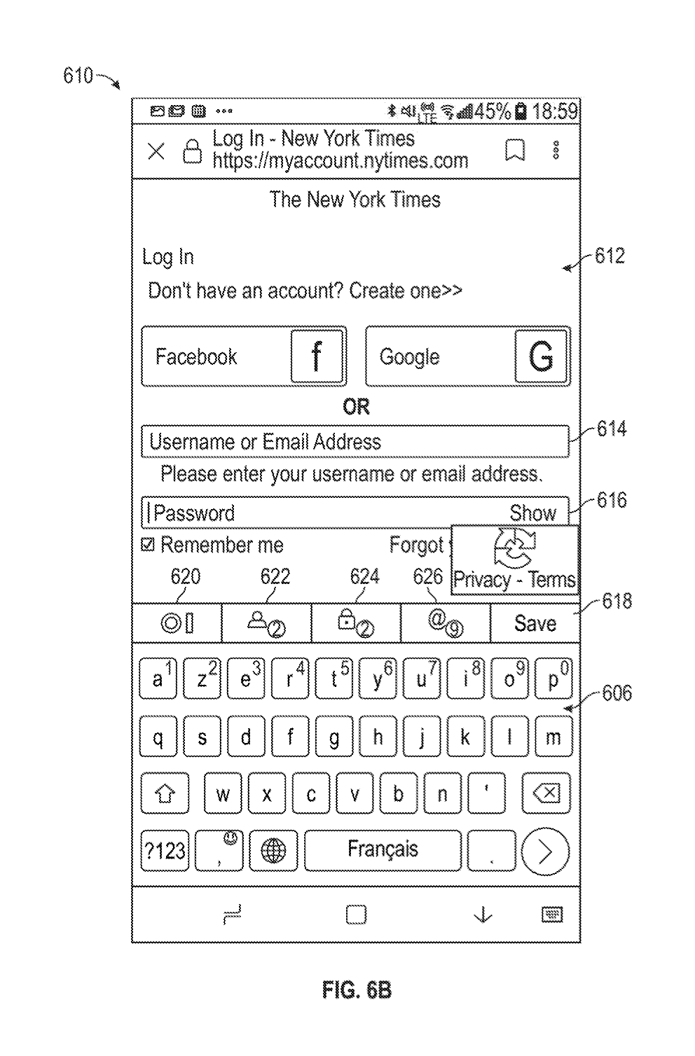

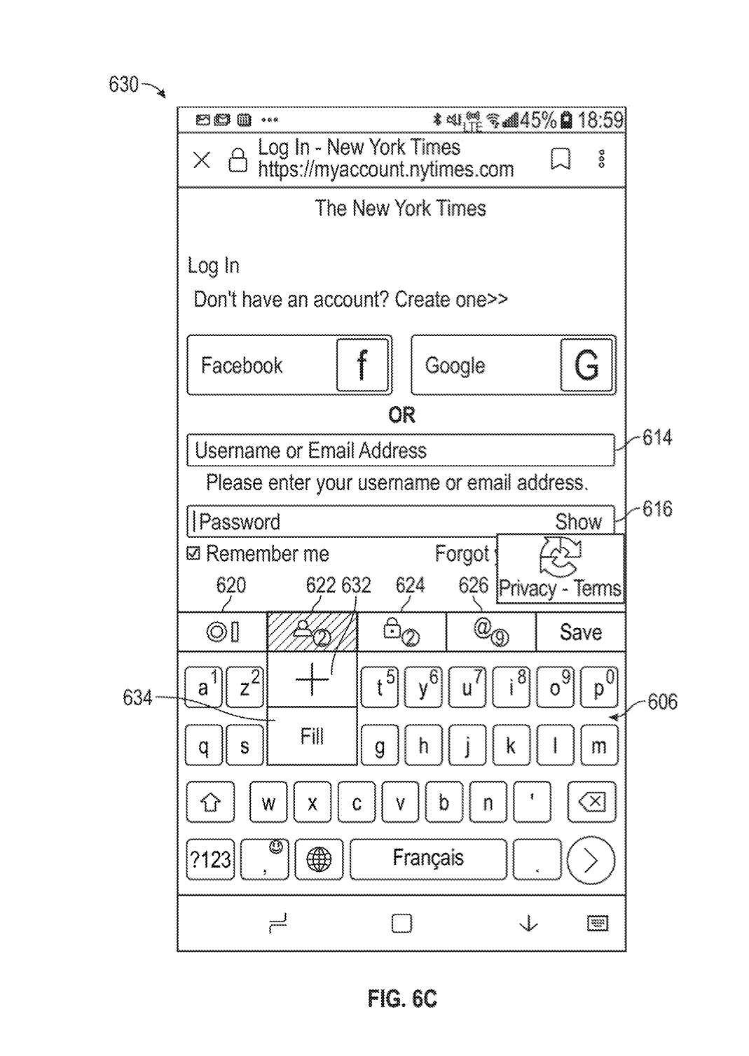

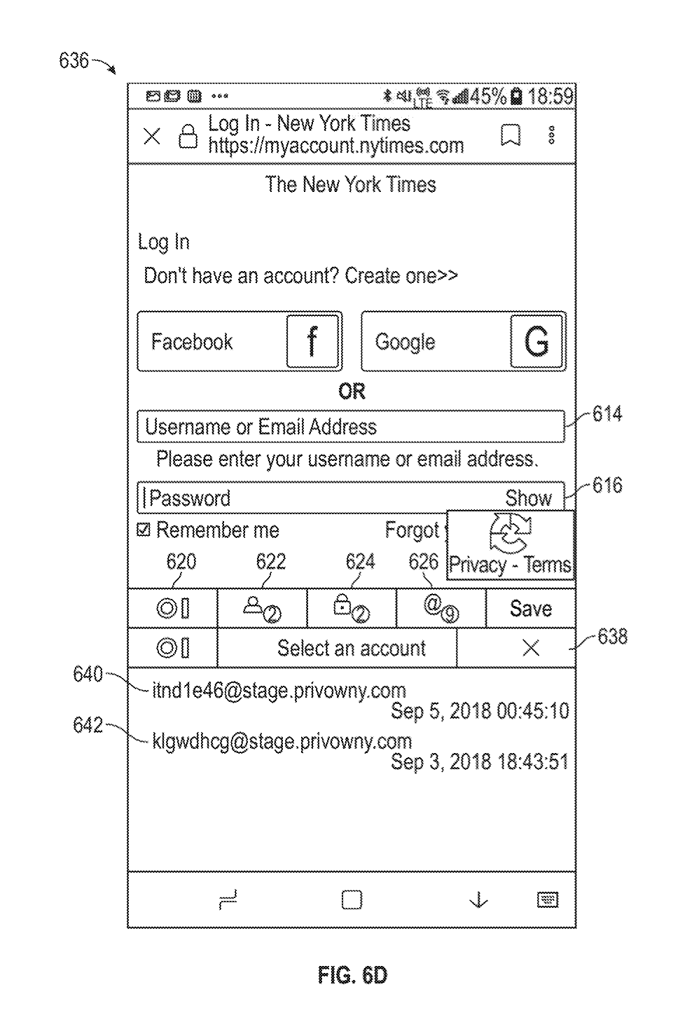

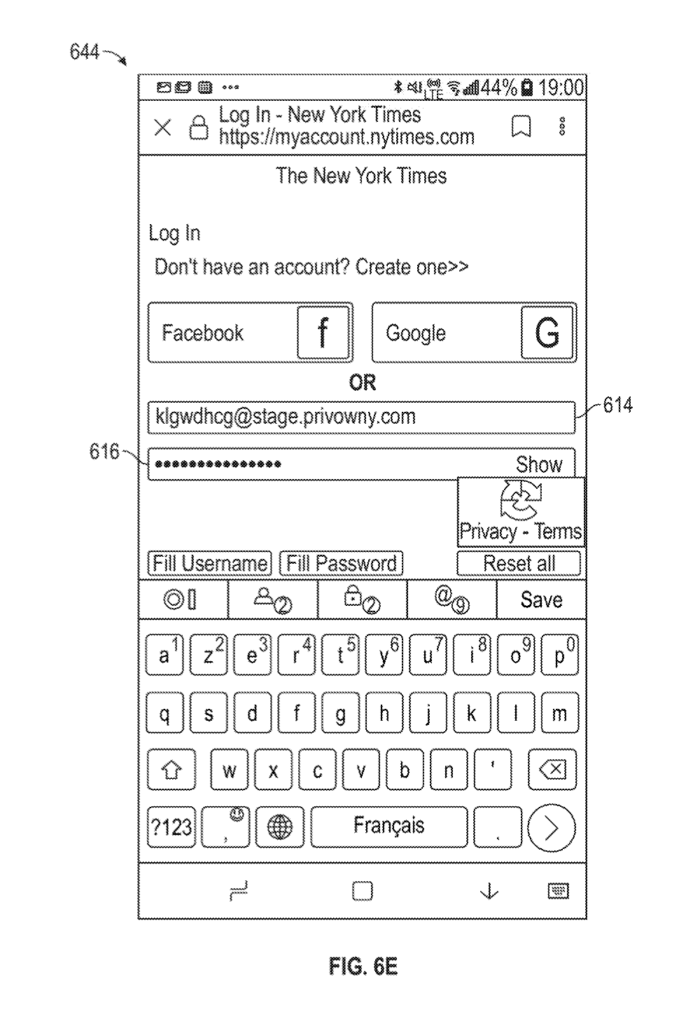

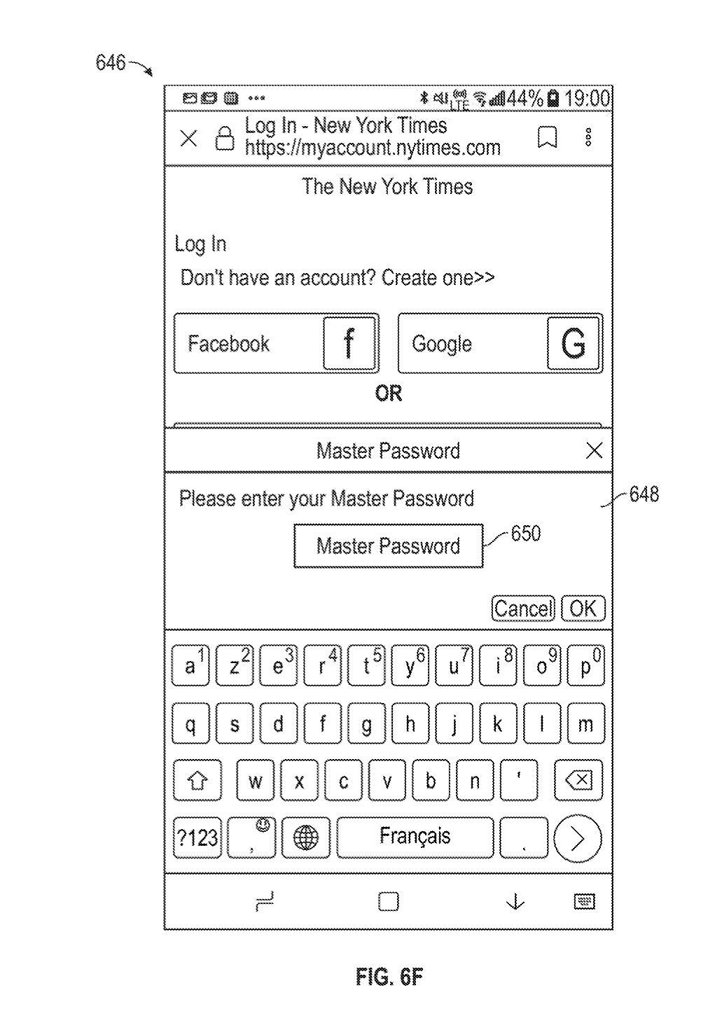

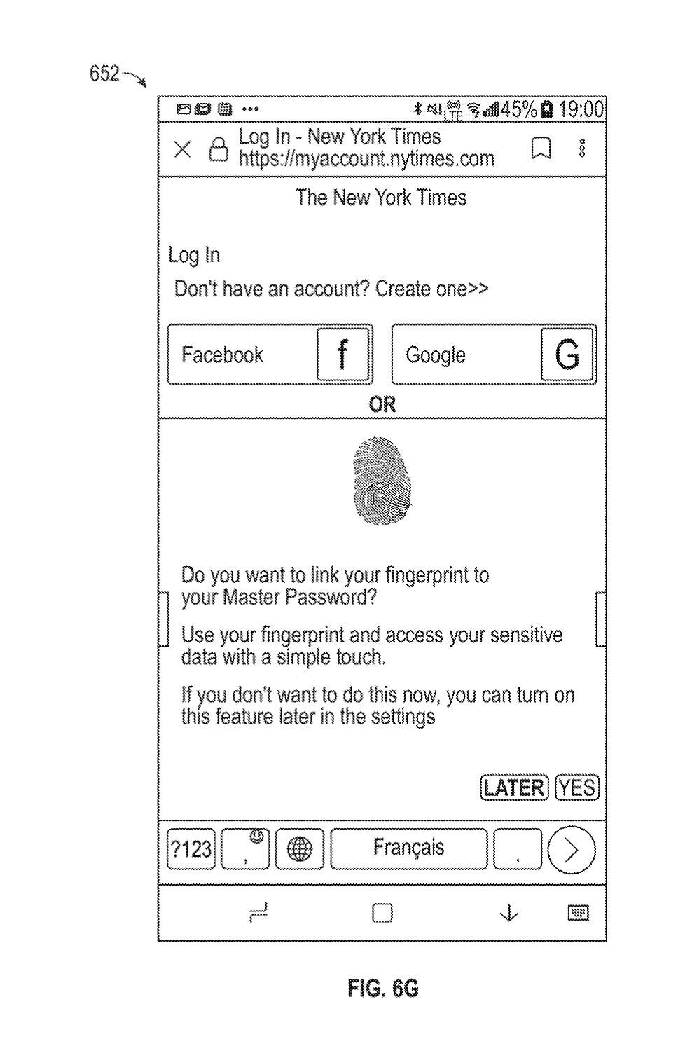

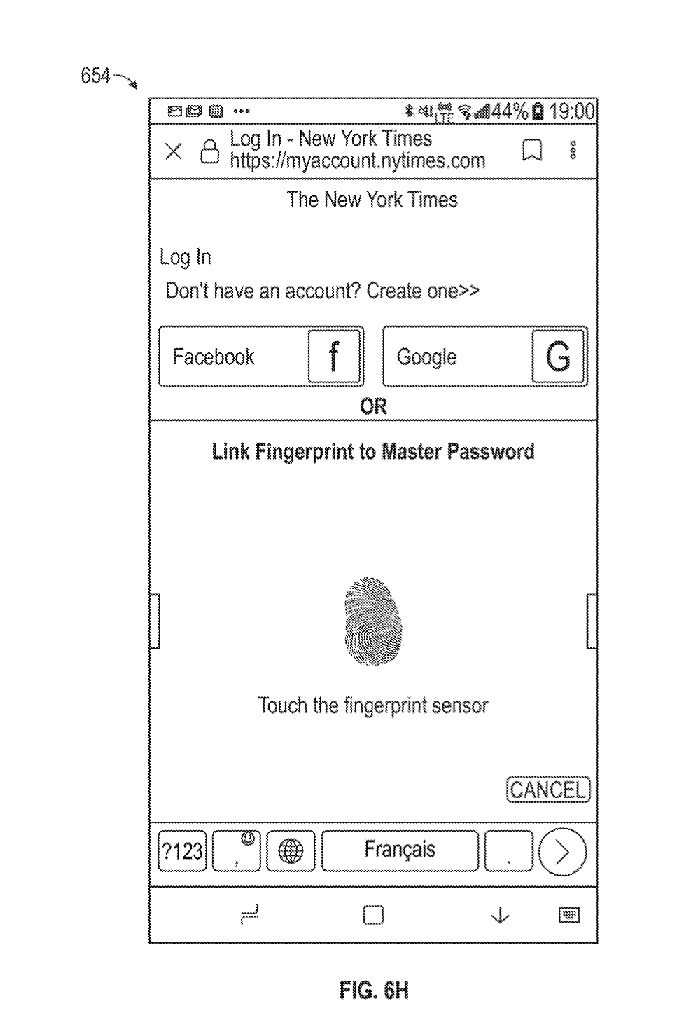

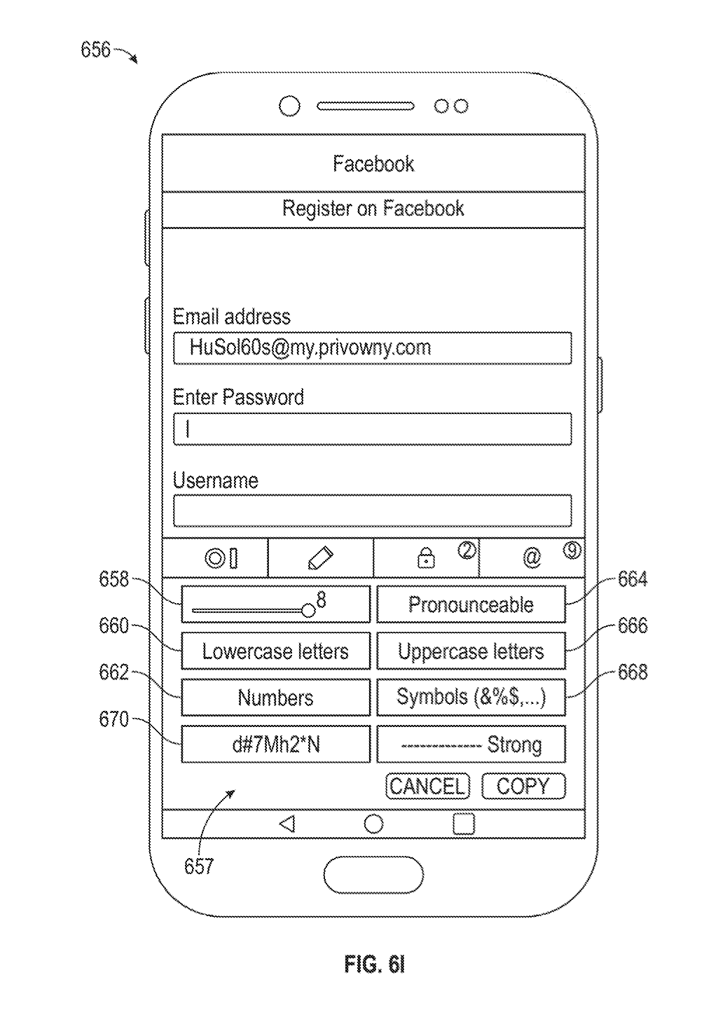

The keyboard engine 506 includes hardware, software and/or firmware configured to generate and present a virtual keyboard. The contextual data interface 508 is configured to generate a form data interface to present the form data to the user (e.g., in the place of the virtual keyboard or in the prediction bar above the keyboard) or give the user access to the form data (e.g., by presenting an account identifier, rather than the form data itself). In some embodiments, the contextual data interface 508 may enable the user to access the form data using a hierarchy of interfaces, e.g., a first interface for enabling the user to select an account or account identifier, a second interface for enabling the user to select first form data of a first type (e.g., a username), a third interface for enabling the user to select second form data of a second type (e.g., a password), and so one. In some embodiments, the contextual keyboard interface 506 is further configured to present an interface for enabling the user to request the generation of form data, e.g., a new username, a new password, or a new alias email address. In some embodiments, the contextual keyboard interface 506 provides the interface to the user to request password preferences and/or password requirements of the form page, so that the password generated by the data control server system 104 adheres to the appropriate form page rules. The keyboard engine 506 may generate at least part of the client device interfaces shown in FIGS. 6A-6I.

FIG. 6A depicts a client device interface 600, in accordance with some embodiments of the present invention. In some embodiments, the client device interface 600 includes an email generating interface 604 generated by the browser 112 or local app 114 and includes a virtual keyboard 606 generated by the contextual keyboard system 118. Between the email generating interface 604 and the virtual keyboard 606 is a prediction interface 608. The prediction interface 608, which may also be generated by the contextual keyboard system 118, may present conventional word predictions (like the standard virtual keyboard) when the form-filling services are deemed not to be required.

FIG. 6B depicts a client device interface 610, in accordance with some embodiments of the present invention. In some embodiments, the client device interface 610 includes a New York Times login page 612 generated by the browser 112 or the local app 114, and includes a virtual keyboard 606 generated by the contextual keyboard system 118. The New York Times login page 612 is shown to be located at the URL https://myaccount.nytimes.com. The New York Times login page 612 includes a first field 614 requesting a username or email address. Notably, the first field 614 includes a text prompt indicating “Username or Email Address”. The New York Times login page 612 also includes a second field 616 requesting a password. Notably, the second field 616 includes a text prompt indicating “Password”. The client device interface 610 further includes a prediction interface 618, which may also be generated by the contextual keyboard system 118. In some embodiments, the prediction interface 618 may present a variety of form-filling keys, including an on/off key 620, a username key 622, a password key 624, and an alias key 626. As shown by the prediction interface 618, the client system 116 has retrieved two login options, two password options, and nine alias options. In some embodiments, this may represent that the user has two separate accounts with the New York Times, and that the user can select between them. In some embodiments, if the user selects one of the two accounts, the associated password will be specified.

FIG. 6C depicts a client device interface 630, in accordance with some embodiments of the present invention. The client device interface 630 includes the same elements as the client device interface 610, except that the user has selected the username key 622. Being selected, the username key 622 requests the user to either select the plus sign (“+”) key 632 to request a new username or the select the “Fill” key 634 to enable the user to select one of the username of one of two accounts.

FIG. 6D depicts a client device interface 636, in accordance with some embodiments of the present invention. The client device interface 630 includes the same elements as the client device interface 610, except that the user has selected the “Fill” key 634. In response, the virtual keyboard 606 is replaced by two email address login options, namely, a first email login option 640 and a second email login option 642. Notably, both email login options show a “privowny.com” domain, indicating that both email addresses are alias email addresses. The user is prompted to select one of the email login options for entry into the first field. 614.

FIG. 6E depicts a client device interface 644, in accordance with some embodiments of the present invention. The client device interface 644 includes the second email login option 642 selected, and thus entered into the first field 614. The client device 644 also includes a password associated with the second email login option 642 entered into the second field 616.

To fill in the password into the second field 616, the client system 116 may obtain the previously used password entered by the user on the current domain/app. For example, the client system 116 may identify metadata about the form page (such as the URL, sequence of URLs, etc.) and form field context information (fields, field names, field default values), and send the metadata to the data control server system 104. From the accessibility service, the client system 116 can read the screen and extract elements of the screen. In some embodiments, as part of provisioning, the client system 116 or the data control server system 104 may have been fed with meta-information about form pages and form fields. For example, in some embodiments, the client system 116 or the data control server system 104 knows that the facebook.com login page contains two fields with text prompts “Email address or phone number” and “Password.” Based on the context information, the client system 116 may predict that, if user has one account or has selected one account, the form data for this account will be used in a specific order and sequence of user clicks. By positioning the cursor into each of the first and second fields, the contextual keyboard system 118 may fill the first and second fields with the form data on behalf of user.

FIG. 6F depicts a client device interface 646, in accordance with some embodiments of the present invention. The client device interface 646 includes a pop-up window requesting that the user enter the master password before gaining access to the services of the client system 116 or of the data control server system 104.

FIG. 6G depicts a client device interface 652, in accordance with some embodiments of the present invention. The client device interface 652 asks the user whether the user wants to register with the client system 116 or data control server system 104 via Facebook or Google, and asks the user whether the user want to link biometric information such as the fingerprint stored on the client device 106 and available to access the client device 106 as a substitute for the master password.

FIG. 6H depicts a client device interface 654, in accordance with some embodiments of the present invention. If in FIG. 6G, the user has decided to link the biometric information to the password, the client device interface 654 informs the user that the link has been completed.

FIG. 6I depicts a client device interface 656, in accordance with some embodiments of the present invention. The client device interface 656 includes a password generating section 657, which enables the user to inform the client system 116 of the password preferences of the user or of the password requirements of the password field of the form page. The password section 657 includes field 658 that requests the password length, field 660 that requests whether to use lower case letters, field 662 that requests whether to use numbers, field 664 that requests whether the password should be pronouceable, field 666 that requests whether the password should use uppercase letters, and field 668 that requests whether the password should use symbols. The client system 116 may send the request to the data control server system 104, which returns the generated password based on the request. The password generated by the data control servers system 104 is presented in field 670.

FIGS. 7A and 7B depict examples of components suitable for providing the systems and methods described in this paper. FIG. 7A depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the relevant art.

The web server 704 is typically at least one computer system that operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a media data store. While two computer systems 704 and 706 are shown in FIG. 7A, the web server system 704 and the server computer system 706 can be one computer system having different software components implemented on hardware and providing the web server functionality and the server functionality provided by the server computer system 706, which will be described further below.

Access to the network 702 is typically provided by Internet service providers (ISPs), such as the ISPs 710 and 716. It is also possible to use Mobile and Mobile Network operators that deliver fixed Internet connections. In the case of Mobile, access to the Internet is often through 3G, 4G, GPRS, EDGE, etc. Also, Wifi is a way to access the Internet that is provided differently. A person of skill in the relevant art will recognize that known and convenient ways to access the Internet can be used. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP. In the case of Mobile, sometimes an application server, rather than a Web Server is used, and this may be the case for PC applications, such as iTunes, games, etc. that are not using any web server nor a browser. A person of skill in the relevant art will recognize that applications are increasing and can use known or convenient technologies to obtain documents.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. A person of skill in the relevant art will recognize that the connection mechanisms, such as modem interface 714, can be modified or replaced with known or convenient technologies to make use of various networks, such as GPRS, EDGE, 3G, 4G, etc. The client computer system can be a personal computer system, a network computer, a web TV system, or other computer system. While FIG. 7A shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7A, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be Ethernet or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 7B depicts a computer system 740 for use in the networked system 700 of FIG. 7A. The computer system 740 may be a conventional computer system that can be used as a client computer system or a server computer system or as a web server system. Such a computer system can be used to perform many of the functions of an Internet service provider, such as ISP 710.

The computer system 740 may include a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. A computer can include Mobile and any other connected device that has a processor. The communications interface can be an analog modem, ISDN modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor, or some other conventional or unconventional processor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with applicable known or convenient technology.

The non-volatile storage 756 is often a magnetic hard disk, an optical disk, or another form of storage for large amounts of data. Some of this data is often written, by a direct memory access process, into memory 752 during execution of software in the computer 742. Objects, methods, inline caches, cache states and other object-oriented components may be stored in the non-volatile storage 756, or written into memory 752 during execution of, for example, an object-oriented software program. In this way, the components illustrated in, for example, FIGS. 1-6 can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system that can be used to implement techniques described in this paper. Network computers do not usually include a hard disk or other mass storage, and the executable programs are loaded from a network connection into the memory 752 for execution by the processor 748. A Web TV system is also considered to be a computer system, but it may lack some of the features shown in FIG. 7B, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Depending upon implementation-specific or other considerations, functionality of an engine can be centralized or distributed. An engine can include special purpose hardware, firmware, or software embodied in a computer-readable medium for execution by the processor. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus may be specially constructed to implement techniques described in this paper, or it may comprise a general purpose computer selectively activated or reconfigured by a computer program stored in the computer to produce a specially purposed machine. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments.

While aspects of the invention have been described by way of example in terms of certain embodiments, it will be appreciated by those skilled in the relevant art that certain modifications, permutations, and equivalents thereof are within the scope of the invention. It is therefore intended that the following appended claims include all such modifications, permutations and equivalents as fall within the true spirit and scope of the invention.

1. A client device comprising:
at least one hardware processor;
memory storing a browser, one or more local apps, and instructions that, when executed by the at least one hardware processor, cause the system to perform the following steps:
monitoring one or more applications, the one or more applications including the browser and the one or more local apps;
recognizing that the user has encountered a form page with a particular application;
identifying particular context information associated the particular application and the form page;
transmitting the context information to a remote server system, the remote server system storing form data associated with the particular context information;
receiving the form data from the remote server system; and
presenting a virtual keyboard interface to the user, the virtual keyboard interface enabling the user to access the form data and enter the form data into the form page.

2. The client device of claim 1, wherein the particular context information includes a URL.

3. The client device of claim 1, wherein the particular context information includes an active application.

4. The client device of claim 1, wherein the particular context information includes a text prompt.

5. The client device of claim 1, wherein the particular context information includes a data type.

6. The client device of claim 1, wherein the form data includes a user name and a password.

7. The client device of claim 1, wherein the form data includes an alias email address.

8. The client device of claim 1, wherein the virtual keyboard interface is a replacement keyboard for a standard keyboard on the client device.

9. The client device of claim 1, wherein the virtual keyboard interface includes a prediction bar that presents form data options for form data fields in the form page.

10. The client device of claim 1, wherein the virtual keyboard interface includes an interface for enabling the user to select an account from a plurality of accounts.

11. A method comprising:
monitoring one or more applications, the one or more applications including a browser and one or more local apps;
recognizing that a user has encountered a form page with a particular application;
identifying particular context information associated the particular application and the form page;
transmitting the context information to a remote server system, the remote server system storing form data associated with the particular context information;
receiving the form data from the remote server system; and
presenting a virtual keyboard interface to the user, the virtual keyboard interface enabling the user to access the form data and enter the form data into the form page.

12. The method of claim 11, wherein the particular context information includes a URL.

13. The method of claim 11, wherein the particular context information includes an active application.

14. The method of claim 11, wherein the particular context information includes a text prompt.

15. The method of claim 11, wherein the particular context information includes a data type.

16. The method of claim 11, wherein the form data includes a user name and a password.

17. The method of claim 11, wherein the form data includes an alias email address.

18. The method of claim 11, wherein the virtual keyboard interface is a replacement keyboard for a standard keyboard on the client device.

19. The method of claim 11, wherein the virtual keyboard interface includes a prediction bar, and further comprising presenting form data options in the prediction bar part of the virtual keyboard interface, the form data options being for form data fields in the form page.

20. The method of claim 11, further comprising enabling the user to select an account from a plurality of accounts using the virtual keyboard interface.
